(19) United States
(12) Patent Application Publication
(10) Pub. No.: US 2012/0061033 A1
(43) Pub. Date: Mar. 15, 2012

(54) WINDBREAK SYSTEM

(76) Inventors: Francisco Oña González, Malaga (ES); Jorge Luis Pérez Falcón, Malaga (ES)

(21) Appl. No.: 13/321,433

(22) PCT Filed: Apr. 28, 2010
(86) PCT No.: PCT/ES10/00187

§ 371 Date: Nov. 18, 2011

(30) Foreign Application Priority Data
May 25, 2009 (ES) P200901275

(51) Int. Cl. E06B 3/50; E05D 15/58

(52) U.S. Cl. 160/205

(57) ABSTRACT

The invention relates to a windbreak system formed by a set of independent, folding panels that move longitudinally along an upper guide rail and another, lower guide rail and a non-movable folding door, in which each panel and the door include a rotating shaft and folding shaft. The panels are moved manually and do not have rollers, the entire weight of the panels resting on two strips of self-lubricating polymer inserted into slots in the lower rail.

### FIELD OF THE INVENTION

The present invention is a system made of aluminium, glass and steel made of independent panes that allow the delimitation, enclosurements, or isolation of spaces, either in houses (balconies, patios, porches . . . ) or in businesses (restaurants, offices . . . )

This invention can be included into the technical sector of building systems or materials.

### STATE OF THE ART

At present there are different enclosurements systems in the world based on independent panes made of glass and aluminium, as described in patents SE9902369, F1924654, SE9804540, F1955693 and F1891666. All these systems are based in the use of bearings and wheels and are designed being the weight top hang. Top bearings hold the weight of the system and the bottom ones guide the sliding panes along the bottom track.

These kind of systems using bearings and top hanging are under a continuous stress due to the force of gravity and it is a matter of time they start to show problems and a maintenance is required, such as: panes get stuck, the panes are not well adjusted and don't match perfectly, etc. Also the weight being on top constrains the commercialization possibilities of these systems because the ceiling can't be strong enough to hold that weight without being reinforced, also the fitting process will require an additional effort designing an additional structural ad-hoc solution for every situation.

The invention described in this patent solves these problems cause by the use of bearings and having the weight top hang. The solution doesn't make use of bearings or wheels and the weight of the system is on the bottom instead on the top.

The invention also has a system of sliding tracks designed in such a way that the system becomes waterproof against any possible water leakage, something very common in these systems as the moving panes have joints in between the panes that are not 100% waterproof and, else more, have a progressive aging as they are exposed to the direct sun and other inclement weather conditions.

This invention, unlike other state of the art known systems, allows some certain margin of error in the fabrication of the glasses provided by the suppliers as it has adjustable bottom profiles that overcome the possible imperfections on the glass, such as not perfect rectangular shapes, over or under measurements comparing to the exact measurements of each panel, etc.

Unlike other systems, the turning and guidance mechanisms of the panes are not fabricated following a model of screwing the parts to a plate and then welding them. On the contrary, the screwing process has been replaced for a fixation by pressure of one part into the other and then welding them together. This way the fitting of the components into the plates can be done in a unique way, this helps the installation process and the future safety of the everyday use of the system.

### SUMMARY OF THE INVENTION

The system described is made of a set of independent panes that can be operated manually sliding them along the top and bottom track. The bottom track supports the weight of the panes that slide on it, without any kind of bearings or wheels.

There are two kinds of panes, a fix one called door and the rest are all the same and slide over the bottom track. It is named door because it works exactly as a normal door, i.e. it has an axis to turn around so the system can be open or close. Like normal doors, it has a locking part to open or lock the whole system. The pane called door it is always placed in one of the track ends; the rest of the panes will have to be moved to the door position to be folded. All the panes will be folded in parallel to the door open mode, i.e. orthogonally to the bottom and top tracks direction. All the independent panes are made of glass, tempered or laminated, with a thickness within a range of 6 to 20 mm. The panes slide over the tracks by means of two sliding strips and all the weight rests on the bottom track. The top track works as a guide for the panes, not supporting any weight. All the panes work independently and a person can slide them along the tracks. The panes only have two possible positions or modes. The first one is the folded position, perpendicular to the direction of the tracks, and the second one is the deployed position over the tracks, following the same direction of them, when they are not folded. All the panes can be folded only at the door position. If they are not folded they can be placed at any position along the tracks, offering a great flexibility in the configuration of the panes depending in weather conditions (wind, heat, cold . . . ). For example, a pane can be followed by an empty space of the same size as a panel, followed by another pane and so on. Obviously, to achieve this configuration half of the panes must be folded at one end of the track.

The glass is always glued to a top and bottom aluminium profile; there are no fixing screws in between glass and profile.

The top part of the profile includes two arms, each of them having two tiny prominences in the inner face and a base where the glass fits on. Two side arms extend down, from the base of the profile, resulting in a trapezoidal shape that is opened on the bigger side. Inside the trapezoid there is a flat steel plate that joins the pane profile to the top axis part. This part goes into the top track by means of a stainless steel T axis-guide and a piece called top guide bushing, made of polyamide or similar material, and allows the longitudinal sliding movement over the top track.

The bottom part of the profile includes two arms and a base. Each arm has two tiny prominences in the inner face and a base where the glass fits on. There are two more arms extend from the base of the profile. This profile has an H shape. This profile is assembled into another profile, the sliding profile, by means of bolts. These bolts allow a regulation in height of the H shape inside the sliding profile to correct any mismatch in the glass measurements because it is usual the glass supplier can not supply glasses with a precision better than 2 mm. This sliding profile has two upper arms to hold the H shape profile, where the glass is glued.

Because the sliding profile contains the H profile where the glass is glued, it makes invisible any possible internal adjustment to correct any mismatch in the glass measurements. Otherwise, the profiles in the joints of two panes wouldn't be aligned and the visual effect would be quite poor.

From the bottom of this profile extend down two lower arms, resulting in a trapezoidal shape that is opened on the bigger side. Inside the trapezoid there is a flat steel plate that joins the pane profile to the top axis part. This part goes into the bottom track by means of a stainless steel T axis-guide and a piece called bottom guide bushing, made of polyamide or similar material, and allows the longitudinal sliding movement along the bottom track.

The bottom guide bushing is made of one piece with five different steps or layers of different sizes:
An oval base with two straight long sides.
A cylinder with a bigger diameter that is in contact with the internal sides of the bottom track.
Another cylinder that acts as a step between the upper and lower cylinders.
A cylinder with a smaller diameter that is in contact with the internal sides of the bottom track. This cylinder fits into the upper opening of the bottom track.
Finally, on top of the smaller diameter cylinder there is a fourth cylinder with a diameter slightly bigger than the opening of the bottom track. This is this way to avoid the bottom guide to drop inside the bottom track.

The bottom track has a rectangular shape with the base closed. The upper part is partially opened. The opening in the bottom track has two equidistant internal sides in the inner area but not for the outer ones, that partially close it. In the upper sides that partially close the opening there are two equidistant channels, with a depth of 4 mm, equidistant to the longitudinal axis of the track, where the sliding strips, made of a mixture of self-lubricating polymers, fit perfectly. The weight of every pane rests on these two strips. These two channels have a perpendicular 7 mm width channel to accommodate brushes. There is a third channel designed to collect any possible water leakage from the outside, making it waterproof. This channel has holes, every certain length, along the track to collect the water from the channel and let it flow to the interior of the bottom track, and from there, to the exterior through the evacuating holes in the outer face of the track. The bottom track is fixed to the floor using self-tapping screws.

Inside the trapezoid there is a steel plate crossed by the bottom axis-guide. This steel plate also works as a fixation for the bottom guide bushing, that is placed inside the bottom track. These parts allow a fine adjustment of the profile to the bottom track in order to achieve an optimal assembly between the profile and the self-lubricating strips, made of a mixture of polymers, where the weight of the pane rests, allowing an optimal sliding operation of it.

The top edge of the glass is glued to an aluminium H profile, in particular, to two arms of this profile and the base of this profile has a trapezoidal shape, and with the upper part opened, being this the bigger side of the trapezoid. The base is the smaller side that holds two arms. Inside the trapezoid there is a set of parts that is called the upper part of the top axis. These parts are:
Top bushing guide: it is made of plastic with a circular shape and is placed inside the top track. This bushing guide is made of polyamide or similar materials and it has two cylindrical steps or layers with different diameters. The lower cylinder has the bigger diameter and is in contact with the inner sides of the top track. The upper cylinder has a smaller diameter. The bushing guide has a circular hole inside to let the T axis-guide go through it, being the diameter of the circular hole smaller than the smaller one of the head in the T axis-guide
A T axis-guide made of stainless steel, having the head of this part an oval shape with two straight long sides.
A stainless steel clip to position the top bushing guide in the right position at a certain height of the T axis-guide.

The head of the axis-guide fits into the turning mechanism. The base of this T axis-guide crosses the open side of the trapezoid shape of the top profile, profile that holds the glass in the opposite hole, and joins to the steel plate placed inside the trapezoid hole of this profile. This steel plate has two holes of identical diameter and another one with a semicircular shape, placed along the longitudinal axis of this part. The steel plate has a rectangular shape with three straight sides and one small side in a rounded shape. The T axis-guide fits in the semicircular shape hole that is closer to the rounded shape side, which is closer to the edge of the pane or door. This steel plate is positioned over the trapezoidal profile area with the help of two endless screws, screwed into the circular holes with identical diameters, until they press the edges of the open side of the trapezoid and fix the plate to the profile. The purpose of this steel plate is keeping the profile close to the top track with the help of the components of the T axis-guide part. These parts are not designed to stand the weight of the panes, as it rests on the bottom of the system.

The top track is identical to the bottom track. There are two small channels with a depth of 4 mm, and inside those channels a perpendicular notch with a length of 7 mm for the brush, placed at an equidistant position from the longitudinal axis of the track. The additional channel is designed to collect any water leakage in the bottom track and can be used as a fixing notch for embellishing plates in the top track.

The pane called door, is placed at one of the track ends, has a different configuration from the rest of panes, it works as a real door instead of a sliding pane. The top edge of the glass is glued to an aluminium profile, in particular to two arms of this profile. The base of this profile has a trapezoidal shape, with the upper part opened, being this the biggest side of the trapezoid. The base is the smaller side and holds two arms. Inside the trapezoid there is a steel plate that is crossed by an endless screw, the screw head fits inside the top pivot. The top pivot is made of polyamide or similar material with a cubic shape with a hole placed in its centre. This hole has a smaller diameter than the head of the screw that crosses the base of the top track and is screwed to a nut placed on the ceiling to fix it. Another screw comes out the bottom hole, whose circular section has a bigger diameter than the head of the screws, allowing the screw heads to fit inside this part. The bottom part of the door has the same elements between the bottom profile, having a trapezoidal shape, and the bottom track.

These bottom and top guides allow the rotation of the door in both directions. With the help of an endless screw the door can be adjusted to the top track. This axis parts are not designed to stand the weight of the door, that task is done by the bottom track.

There is the possibility of having another door in the system that is not placed at the tracks ends, this door is named sliding door. The configuration of the sliding door is similar to the normal panes, the only difference is that the bottom bushing guide has a cylindrical base instead of an oval one with two straight long sides. Inside the bottom track there is a tramp piece, it has a rectangular form with an open circular shape side to trap the bottom bushing guide of the sliding door and allow the pivoting of this sliding door.

The door, fix or sliding, and all the panes, have in the upper part of the profile, at the opposite side to the pivoting axis, a mechanism, called top guide, made of a bolt that goes through a hollow cylinder made of polyamide. The head of this bolt is bigger than that the diameter of the cylinder in such a way that when is completely screwed in the steel plate, the head is inside the cylinder but like a cap of it. That steel plate is fixed inside the trapezoid of the profile using an endless screw. This steel plate, made of stainless steel, has consequently two threaded holes.

In the bottom track, the bottom sides of the profile trapezoid are in contact with the strips, made of a mixture of polymers, accommodated inside the bottom track channels. Inside that trapezoid is placed a washer with an H shape, it is partially described in between the sides of the open side of the trapezoid hole of the bottom profile, in such a way that the bottom of the H shape washer matches the open side of the bottom track. The washer doesn't rest on the sliding strips made of a mixture of self-lubricating polymers. With the help of a screw that crosses the threaded hole through the longitudinal axis of the H washer and reaches the trapezoid base, this H washer has to be positioned along the bottom profile to pass through the notch made in one of the polymer strips when the panes are folded.

At any of the end of both tracks, where the door is placed, there is a mechanism fitted inside the track. This mechanism has a row of spoon or semicircular shapes. In every spoon hole fits the head of the T axis-guide that is placed in the corner of the top profile in every pane. At this hole will be the point where the turning axis will be operating for every pane while folding.

The top track has a rectangular hole on the interior side from where the panes will be folded, attached to this hole there is a metal piece called guide-arm that will allow the panes to be folded. This hole on the top track allows the pane to pivot and be folded close to the door. The semicircular holes or spoons not only allow the turning movement of the panes but also keep then blocked to avoid up and down movements in the panes when they are in the folded position.

The pivoting of the panes is achieved by making the head of every T axis-guide fit into every turning mechanism spoon placed at the end of the tracks, by the door pivot axis. The spoon shape allocates and assures the exact point of the pivot axis for every pane. Else more, the little tolerance in the matching of the spoon and the head of the T axis-guide, allows a little unbalance pivot movement that helps the opening process of the panes. When a pane folds back, it turns around at the pivot axis that is enabled by the former parts as described before and at the same time the H washer passes through the notch done in one of the sliding strips made of a mixture of polymers in the bottom track. On the top side, the top guide can only get out of the top track through the square hole where the guide-arm is placed.

The door has a rod that operates in conjunction with the bottom lock to open and lock the door and consequently the whole system. The rod is fixed to the guide-arm. This locking system is placed in the indoor side of the system, by doing so the system can not be opened from the outside.

The sliding movement of the panes can be done manually and has to be done individually. The sliding and folding movement of the panes will allow an easy cleaning process of both glass faces. The panes can reach a height of 3.5 mts and be operated manually by a person.

The sliding strips are made of a homogeneous mixture of polymers. This material has optimal properties that allow the aluminium slide easily over it with a minimal effort by the person operating the system. The usage and the years won't spoil these strips because they are very tough and friction-resistant. The wearing-out of this material is almost zero, the same happens with its maintenance.

### BRIEF DESCRIPTION OF THE DRAWINGS

FIG. 1: Sliding pane cross-section at the pivot axis.

FIG. 2: Sliding pane cross-section at the pivot axis, opposite view.

FIG. 3: Sliding pane side view.

FIG. 4: Door cross-section.

FIG. 5: Door cross-section, opposite view.

FIG. 6: Door side view.

FIGS. 7 and 8: Set of panes, folded and unfolded partially, side elevation

FIGS. 9 and 10: Top turning set cross section and top plan.

FIGS. 11 and 12: Bottom turning set top plan and cross section.

FIGS. 13 and 14: Turning mechanism cross section and top plan.

FIGS. 15 and 16: Top and bottom profile side elevation.

FIG. 17: Sliding profile side elevation.

FIG. 18: Top and bottom track side elevation

FIGS. 19 and 20: Guide-arm not folded top plan and folded side view.

FIGS. 21 and 22: Locking system cross section and top plan.

FIGS. 23 and 24: Sliding door bottom pivot set cross section and top plan.

### EMBODIMENT EXPLANATION

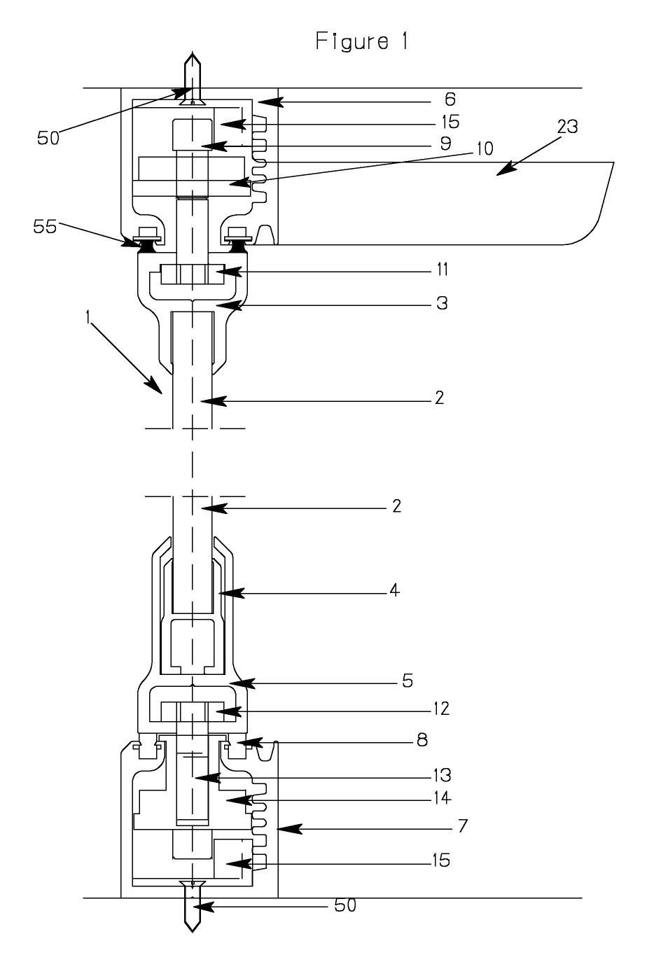

FIG. 1 shows a pane or panel (1) made of glass (2), whose thickness is within a range of 6 to 20 mm. Thicker glass than 20 millimetres would be hardly stand by the structure described in this patent, while a thickness smaller than 6 millimetres implies a reduced isolation, thermal and acoustic performance, as well as poor safety against impacts. The top edge of the glass (2) is fixed by glueing it to a top profile (3) with a trapezoidal H shape and to a bottom profile (4) with a trapezoidal H shape and partially trapezoidal base, contained inside a sliding bottom profile (5) with an H shape with a partially trapezoidal base.

There are two possible pane (1) movements. A longitudinal one sliding over the strips, made of a homogeneous mixture of polymer (8) fitted into two channels (52, 53) in the bottom track, FIG. 18. These two channels (52, 53) are present at the top track (6) and bottom track (7) and they are equidistant from the longitudinal axis of the tracks (6,7). The second pane movement is the turning one by the used of parts allocated in the top track (6) and bottom track (7). In the top of the pane there is a turning part called top turning set formed by a T axis-guide (9), a bushing guide (10) and a steel plate (11). In the bottom of the pane there is a bottom turning set made of a steel plate (12), an “axis-guide (13) and a guide bushing (14). Steel plates (11, 12) are fixed in the top profile (3) hole (39) and in the bottom profile (5) hole (45) of each pane (1) by means of a pair of endless screws, not shown in the figure, screwed across the steel plates and the profiles (3,5). By doing so, the top and bottom turning sets are placed at a certain position into each profile (3, 5).

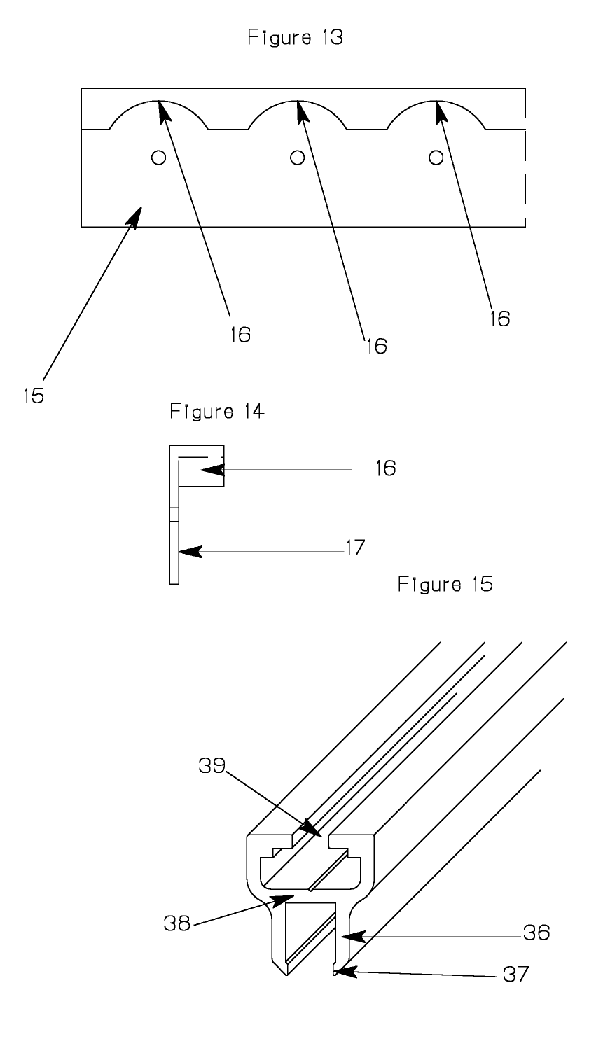

The top turning set (9, 10, 11) pivots on the turning mechanism (15), which is always fitted inside the top track (6) and bottom track (7) nearby the door (24) pivot axis. As shown in FIGS. 13 and 14, this mechanism (15) is a rectangular piece higher than the head of the T axis-guide (13). The flat face is in contact with the interior walls of the tracks (6, 7) being fixed to them by a set of screws. The closest part to the ceiling of the turning mechanism (15) has a set of corners and curves like a spoon shape (16) with a height bigger than the head of the screw (34) or T axis-guide (9). These spoons or half moon shapes (16) receive the head (34) of the T axis-guide (9) of every pane (1) allowing the pivoting movement of the top turning set (9, 10, 11). Each pane (1) will have a unique position defined in each of these spoons (16). The turning mechanism will have as many spoons or half moon shapes (16) as panes in the system (1). These spoons (16) have a 2 mm tolerance with the T axis-guide (9) to enable a smooth operation and without frictions in the metal to metal contact that could damage both parts in the long term. A similar solution is designed for bottom turning set (12, 13, 14). In this case, the turning mechanism spoons (16) receive the lower step of the bottom bushing (14).

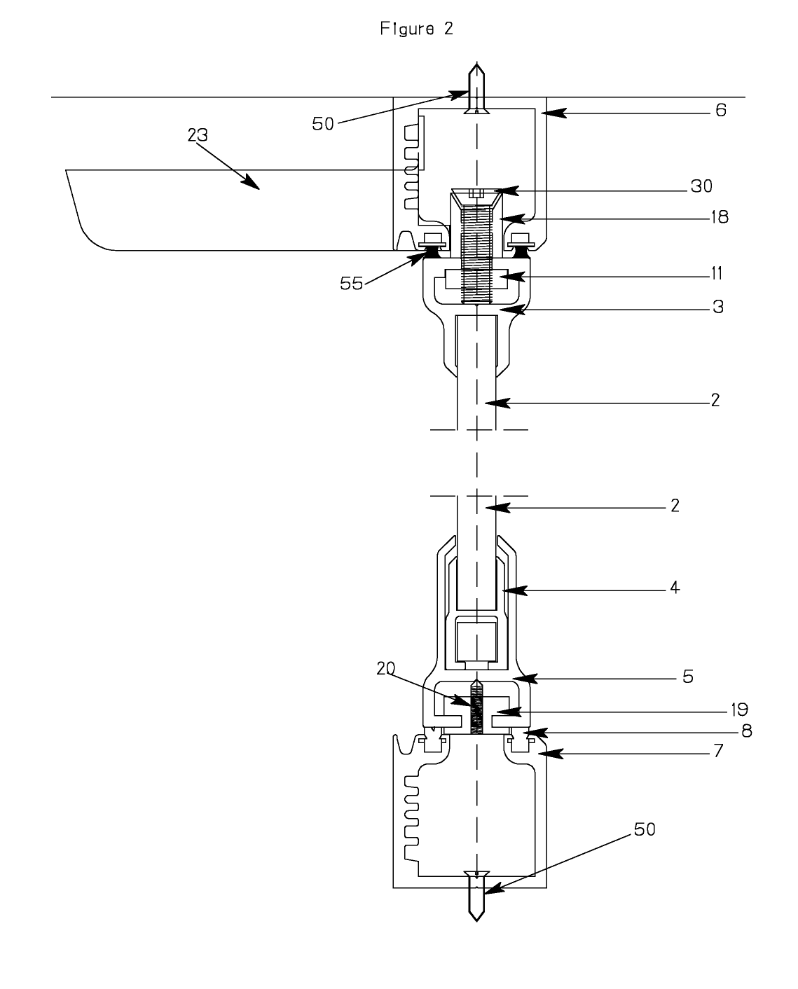

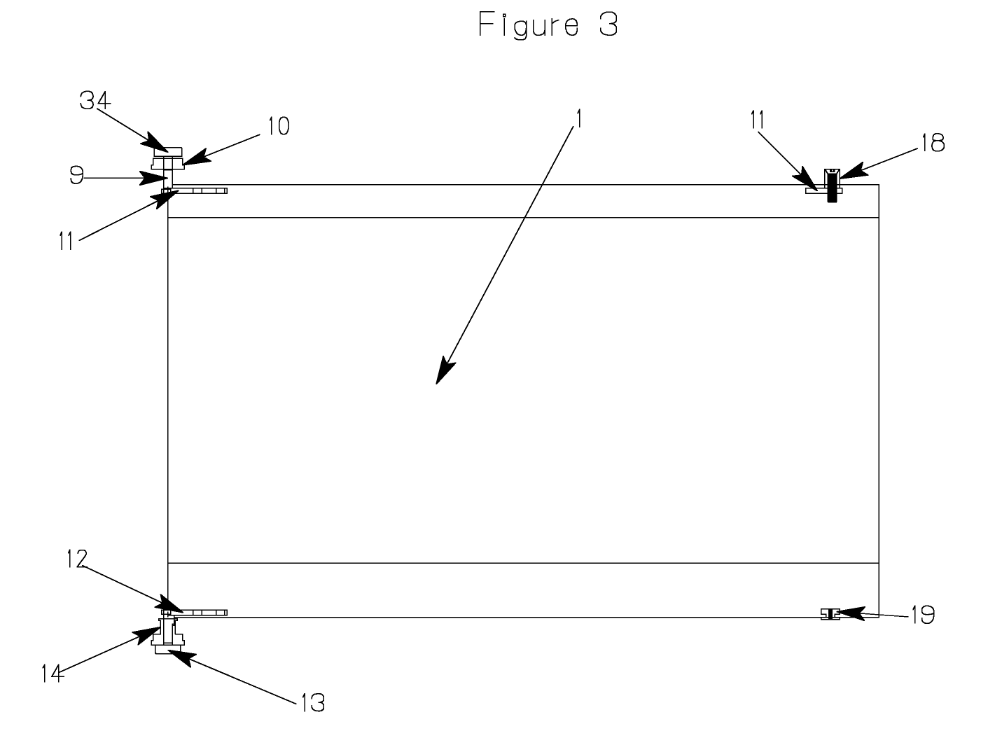

A top and bottom guide set, as shown in FIG. 2, is used to place every pane (1) in the right exit position from tracks, that exit position will define the point of the pivot axis. So, the top turning set (9, 10, 11) and bottom one (12, 13, 14) explained in FIG. 1 work together with the top guide set (30, 18, 11) and the bottom guide washer (19) placed at the opposite side of the pane. The top guide set has these components: a screw (30), crossing a hollow bushing (18) protecting it, it fits into a screw hole in the steel plate (11). The steel plate (11) is fixed to the top profile (6) by means of two endless and headless screws that fit into the inside hole of the top profile (6). When a pane (1) turns around, one side exits from the bottom (7) and top track (6) at a point defined by a hole made in the top track (6). At this hole is placed, using screws, a part to help the pivot movement called guide-arm (23), fitted in a perpendicular direction to the top track (6). The guide-arm (23) works as a lever to pivot the pane (1) in combination with the top guide set (11, 18, 30). The top guide set (11, 18, 30) can be placed in different positions at the top profile (6) of each pane (1) making possible that each pane (1) opens at a precise distance that position the top turning set (9, 10, 11) into its spoon (16), which is part of the turning mechanism (15). The bottom guide is a cylindrical washer with an H shape (19) placed at a certain position inside the bottom sliding profile hole (45) by means of an endless screw. The H washer (19) is made of a plastic element with a double circumference joint by an axis; the top circumference is placed inside the hole of the sliding profile (5) and the axis, with a smaller diameter, fills the gap of the bottom sliding profile (5). The bottom circumference of the H washer (19) doesn't rest on the bottom track (7) as the weight of the panes (1) rest on the inner sides (47) of the bottom profile (5) and therefore on the strips (8). The H washer (19) leaves the bottom track (7) always at the same point. To achieve this, a small notch is done in one of the polymer strip (8). As with the top guide set (18), the H washer (19) can be placed along the bottom profile hole (45) inside the sliding profile (5) by means of a small endless screw that crosses the axis of the H washer (19) and make possible to fix it at a certain position. So, the positions of the components that are part of the top and bottom guide set, i.e., the top guide screw (30), hollow bushing (18), steel plate (11) and cylindrical washer (19), are defined by the folding order in the turning mechanism of their panes (1). This can be seen clearly in the FIG. 3, where the elements that form the top turning set (9, 10, 11) and bottom turning set (12, 13, 14) are placed at the corner of the pane (1), while the elements that form the top guide set (11, 18, 30) and bottom guide (19) are positioned at the opposite corners, the final position is set depending on the folding order of every pane (1) and therefore the pane (1) leaves the top track (6) and bottom track (7) at this point.

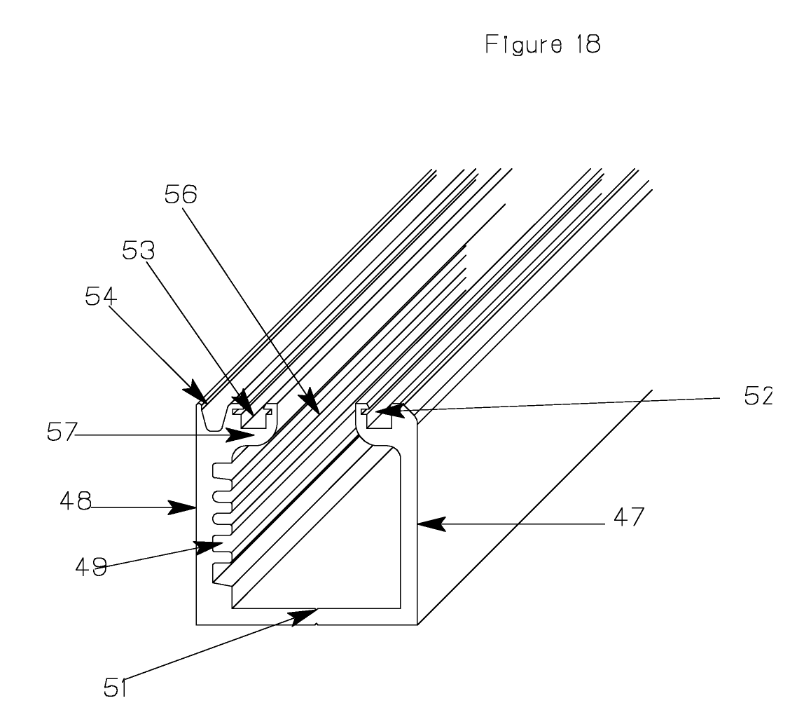

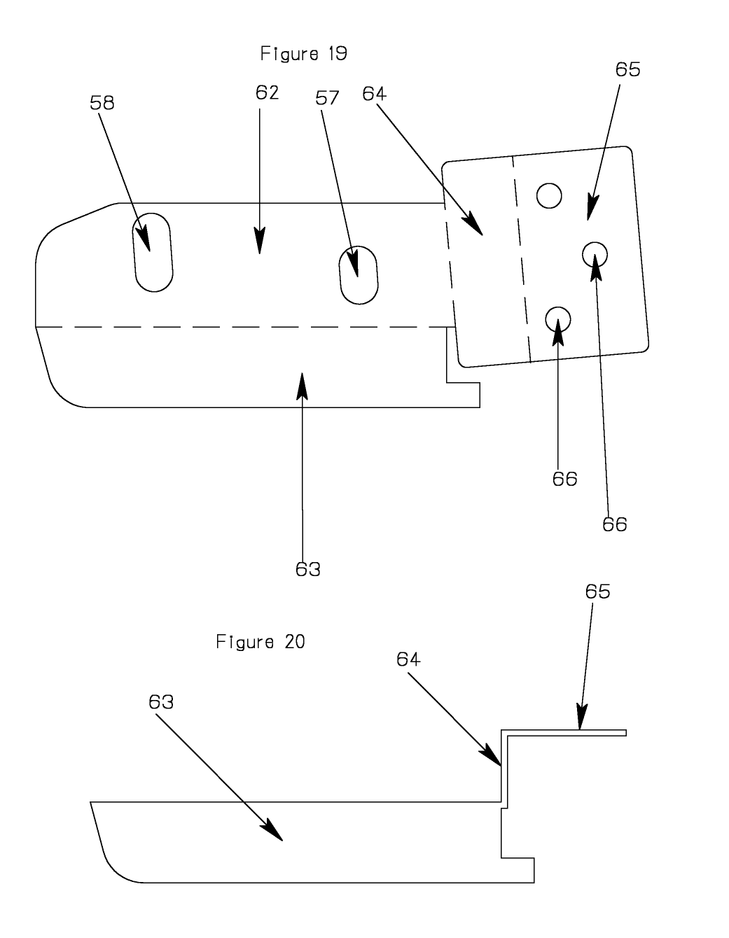

The guide-arm (23) helps the pivot movement of the panes (1) and is perpendicular to the axis defined by the top track (6) and bottom track (7). Else more, it holds the door (24) locking system pin (56). The guide-arm (23) is fitted in a hole done in the top track (6) and, close to the opposite edge of the door (24) pivot axis. The guide-arm (23) is made of stainless steel. As it is shown in the FIGS. 19 and 20, the guide-arm (23) has a flat side (62) parallel to the floor with two holes (57, 58) where a pin (56) can be inserted, the pin (56) is part of the door (24) locking system. This side (62) goes perpendicularly to the top track (6) sides and to the other side (63), in a different axis. The guide-arm (23) is fixed to the top track (6) top inner side using three screws on three holes (66) located at the top step side (65).

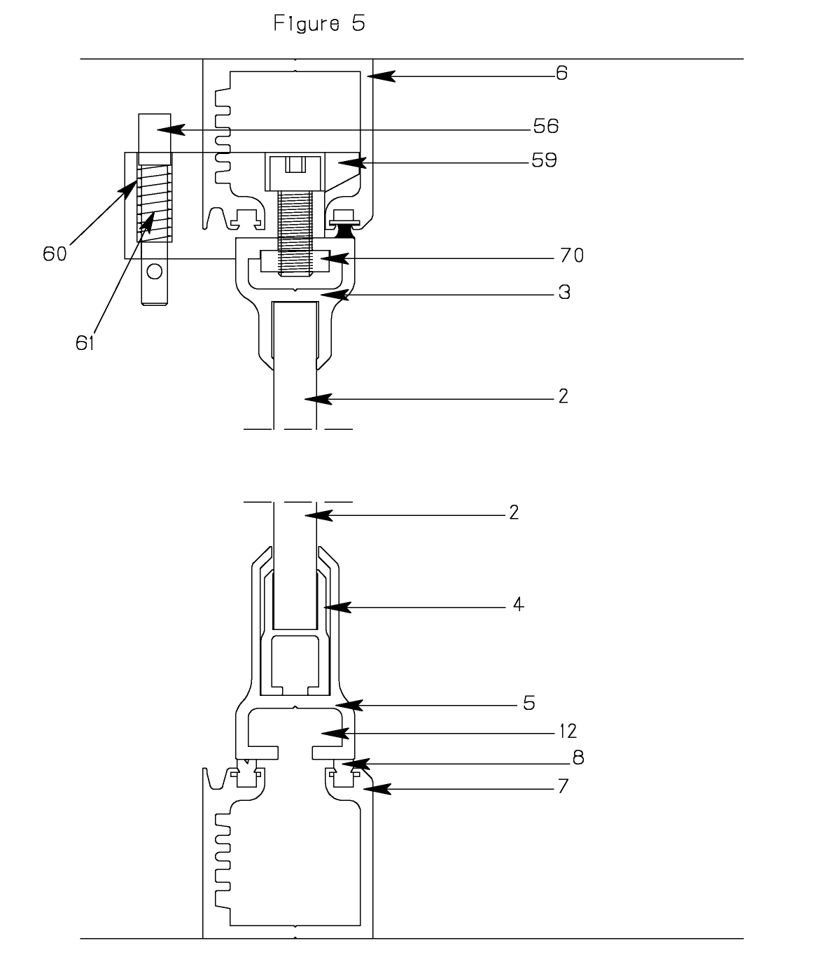

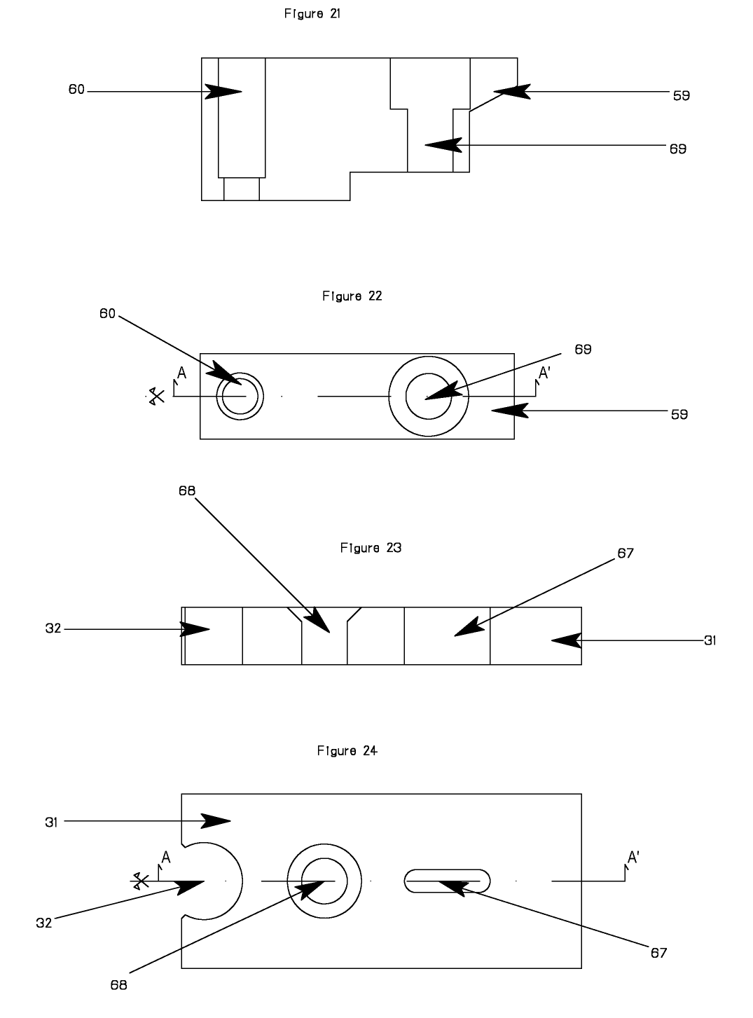

Through the hole done on the top track (6) interior side, and touching slightly the guide-arm (23), the top guide screw (30) and the hollow bushing (18) leave the top track (6). This light touch or levering on the guide-arm (23) makes the folding pivot movement of the panes (1) easier. When the pin (56) of the door (24) locking system (59) is inserted into the guide-arm (23) hole (57) that is closer to the top track (6), the door (24) is locked. Otherwise, when the pin (56) is inserted in the second hole (58) the door (24) is partially opened and locked so the air can pass through the system, this is called ventilation mode. FIGS. 5, 21 and 22 show the door (24) locking system (59) having a hole (69) for a bolt (26) that is screwed to the steel plate (70) placed inside the hole (39) of the top profile (3), this steel plate (70) is fixed to the top profile (4) by means of endless screws.

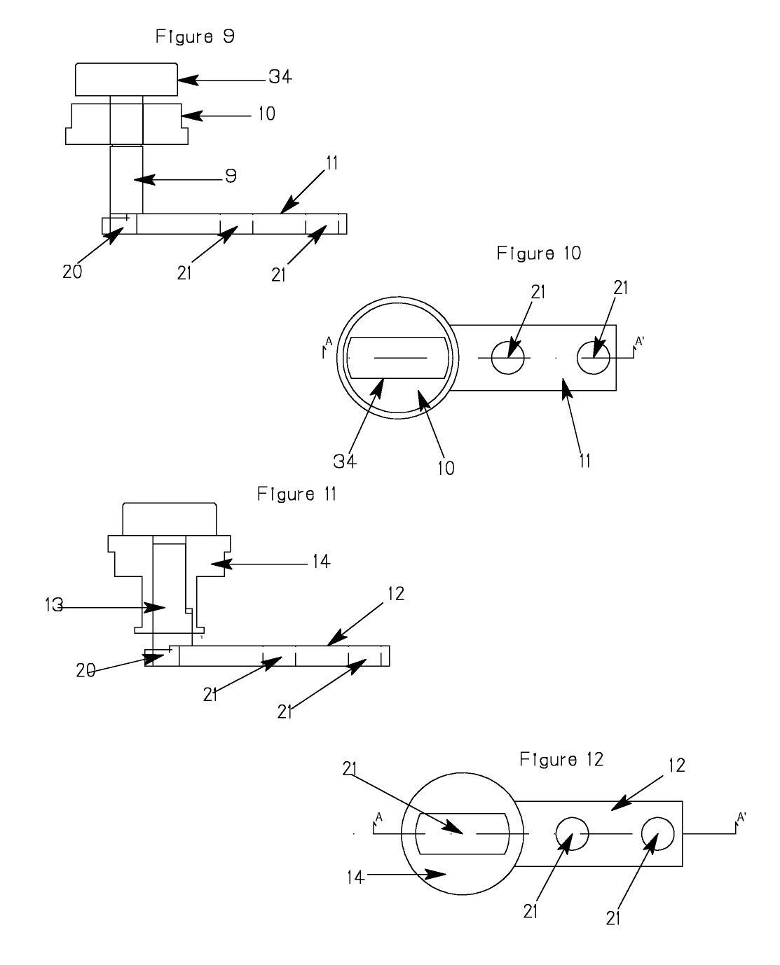

The bushing (10) in the top turning set is made of plastic with a circular shape and is place inside the top track (6), and it has two layers fabricated in one block made of polyamide or similar material, as it is shown in FIGS. 9 and 10.

The steel plate (11), identical to the steel plate (12), it has a long shape and two threaded holes (21) of the same diameter and another hole with a semicircular shape (20) located along the longitudinal axis of the piece. The semicircular hole (20) is placed at one edge of the steel plate (11, 12).

The top T axis guide (9) is made of stainless steel and it has a T form. The head (34) of the axis (9) has two long straight arms with two small oval sides, in such a way that when it pivots this oval side touches the inner side of the spoon (16) in the turning mechanism (15) that delimits the movement of the T axis. The base of the T axis guide (9) has a semicircular shape so it can match perfectly, by pressure, into the semicircular hole (20) in the edge of the steel plate (11). Therefore, the T axis guide (9) is perfectly aligned with the steel plate (11) axis.

The other two threaded holes (21) in the steel plate (11) are designed to place endless screws to fix the top turning set to the top profile (3) in each pane.

FIGS. 11 and 12 show the bottom turning set made of a steel plate (12), an axis guide (13) made of steel, and a bottom bushing guide (14) made of polyamide or similar material, with different layers. The set is fixed to the sliding bottom aluminium profile (5) by means of a steel plate (12), using two endless screws, inserted longitudinally in the trapezoidal hole (45) of the bottom sliding profile (5).

The bottom axis guide (13) crosses the bottom bushing guide (14). This axis (13) is made of steel and is fitted and welded to the steel plate (12) and the other end is inserted into the bottom bushing guide (14) hole, placed inside the bottom track (7). The bottom bushing guide (14) is made of polyamide or similar material and is fabricated in one block with 5 layers that travels along the bottom track (7) hole and guide the pane along that track (7):
An oval base with two straight and long sides, designed to couple into the spoon (16) of the turning mechanism (15).
The biggest diameter cylinder that is in contact with the inner sides of the bottom track (7).
Another transition cylinder working as a step between the top and bottom cylinder.
The smallest diameter cylinder that is in contact with the interior sides of the opened area of the bottom track (7). This cylinder fits into the top opening of the bottom track (7).
Finally, on top of the smallest diameter cylinder there is a fourth cylinder with a slightly bigger diameter than the size of the top opening of the bottom track (7) to hold this bushing and avoids that it falls into the hole of the bottom track (7).

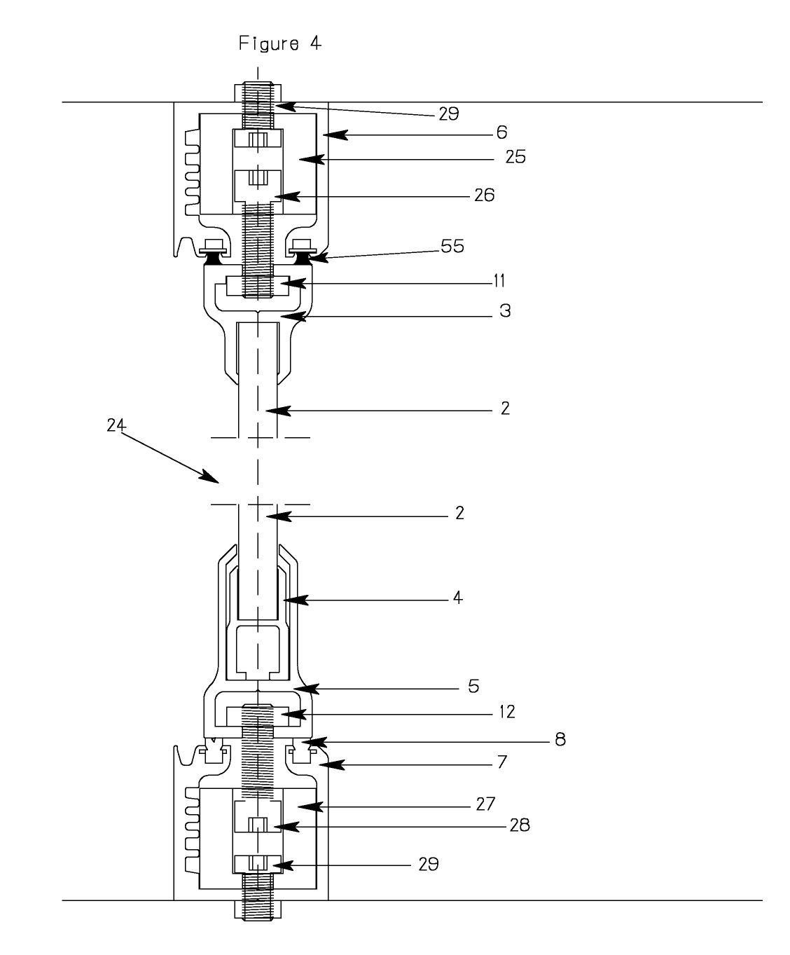

FIG. 4 shows a cross section of the door (24) or opening pane. This is the only pane that doesn't slide and whose only possible movement is to pivot. As the panes (1), the top edge of the glass (1) is fixed to a top profile (3) and to a bottom profile (4) by means of a glueing material. This pane (24) works like a normal door. To do the pivot movement it has a top turning mechanism (25, 26, 11) and a bottom turning mechanism (12, 27, 28).

The operation of both mechanisms are base in an axis formed by screws (26, 28) and steel plates (11 y 12) that fix those axes to the top profile (6) and the bottom sliding profile (7). These steel plates (11 y 12) are fixed to the profiles (3, 5) using endless screws, not shown in this figure. These steel plates (11, 12) adjust the position of the axis in such a way that they can perfectly balance the door (24) position in relation to the top (6) and bottom track (7). The parts that enable the turning movement are two pivots (25, 27) with a cubic shape, made of polyamide or similar material. These two pivots (25, 27) are similar and have a central hole with two openings of different sizes. The one with the biggest diameter receives the head of the screw-axis (26 y 28) and the one with a smaller diameter allows the fixation of these pivots (25 y 27) to the floor and to the ceiling by means of screws (29).

FIG. 5 shows the opposite cross section of the door (24). The elements are the same as described in FIG. 4 except that the position of the top and bottom axes are occupied now by the top door locking system on the top, and a knob to lock the door at the bottom profile. These elements are fixed to the top profile (3) of the glass (2) and to the sliding bottom profile (5) using the same system of steel plates (11, 12) and endless screws.

FIG. 5 shows the door (24) locking system (59) has a small pin (56) that goes up and down and can block the door (24). The pin (56) up and down movement is achieved using a rod (60) and a small internal spring (61). The configuration of the locking system (59) makes the fixing by a screw to the top profile (6) possible.

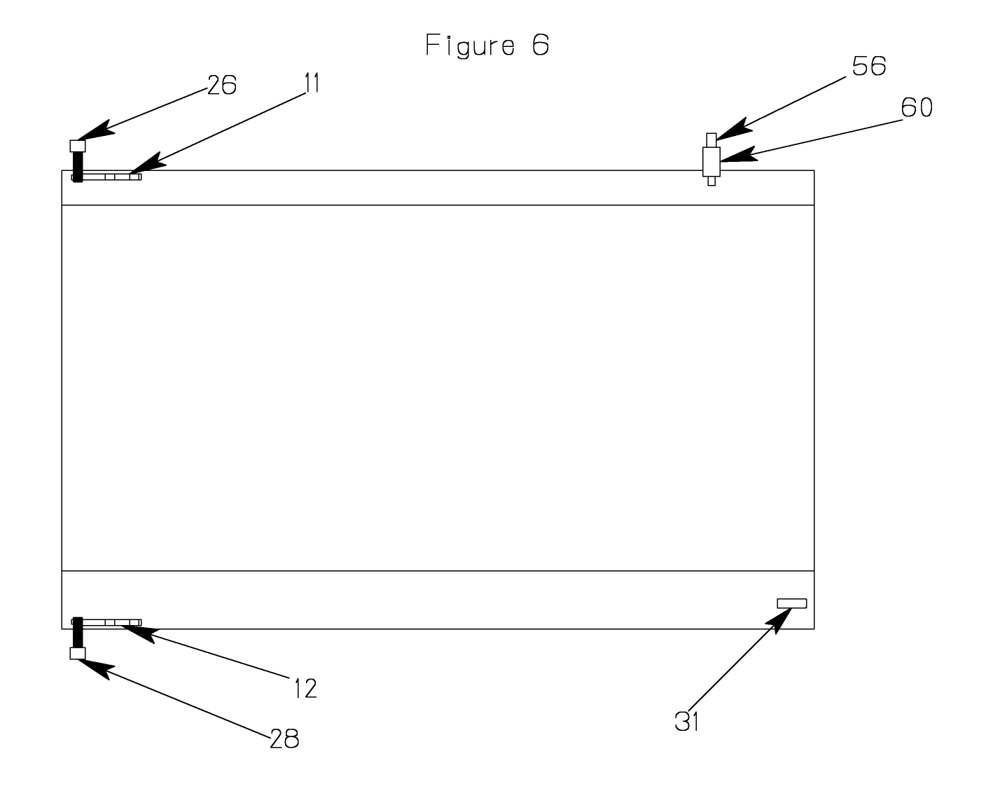

FIG. 6 depicts a front view of the cross section of the door (24) including a rod that in conjunction with a bottom knob enable its opening and therefore the whole system can be operated. The former locking system is place in the interior face of the system, so it is not possible to open the system from the outside.

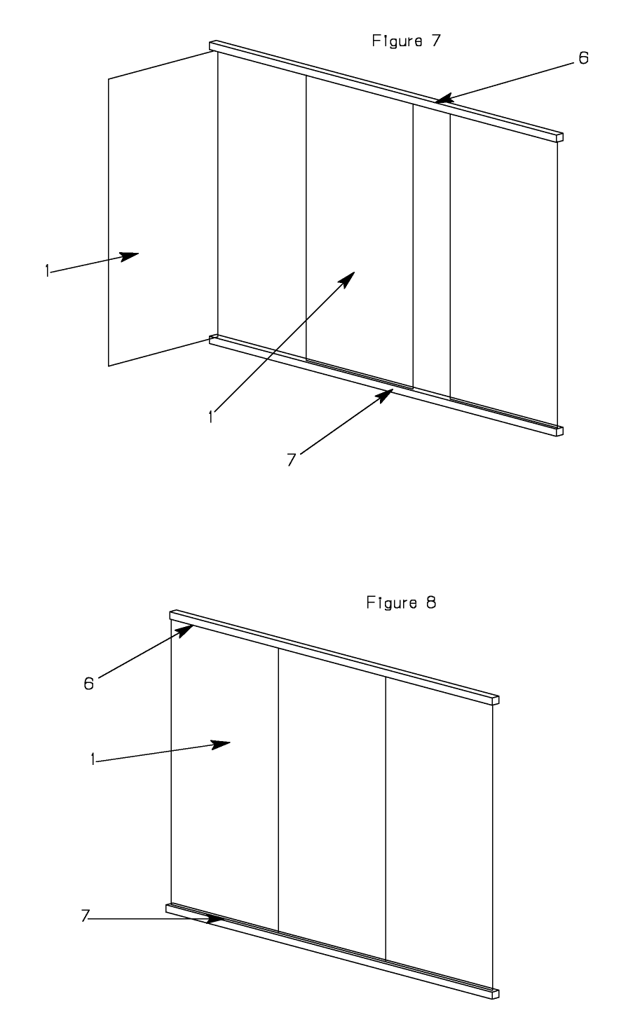

FIG. 7 shows on of the panes (1) in a perpendicular position and folded close to the door, this is the only place where the panes can be folded. Another pane (1) is deployed along the tracks (6, 7) in the unfolded position. FIG. 8 depicts a set of panes deployed longitudinally along the tracks (6, 7).

As shown in FIG. 15, the sides (36) have a flat arm shape and a flat base (38). Glass (2) is glued to the sides (36) and to the flat base of the top track (3). These side arms (36) end with two small protuberances (37) up to 0.5 millimetres long, for a better fixation of the glass (2) to the aluminium. The hole (39) inside the top track has an open rectangular shape. Inside the hole are placed the steel plates (11) to fix the T axis guide (9) and the top guide screw (30). These steel plates (11) hold the parts that fix each pane (1) to the top track (6).

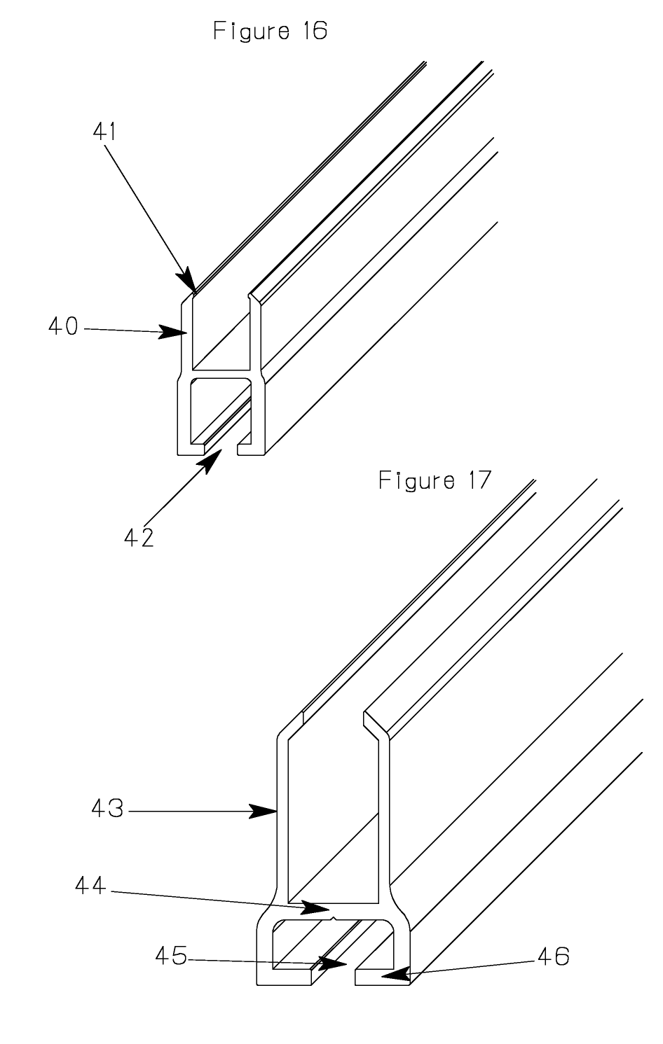

In the bottom aluminium profile (4), FIG. 16 shows that the side arms (40) end with a small protuberance each (41) up to 0.5 millimetres long, for a better fixation of the glass (2) to the aluminium. The rectangular open shape hole (42) can accommodate two screws that fix this profile (4) to the bottom sliding profile (5). These screws work also as height regulators of one profile to the other so the small imperfections in the glass (2) during its fabrication process, one side bigger than the other or slightly not squared sides, can be solved.

FIG. 17 shows that the bottom sliding profile (5) has two straight arms (43) slightly curved on the upper area. The hole contained between those two arms (43) and the base (44) accommodates completely the bottom aluminium profile (4). The base (44) is drilled, so the screw that fixes this profile (5) to the bottom aluminium profile (5), can pass through it. Inside the hole (45) are placed the former screw and the steel plates (12) that fix the bottom axis guide (13) and also the H washer (19). These two elements allow the sliding movement of the panes (2) along the bottom track (7) and the pivot movement at the door (24) area. The outer sides (46) on the bottom of this profile rest on the strips, made of a homogeneous mixture of self-lubricating polymer (8), so the panes can slide along the bottom track (7).

Top (6) and bottom tracks (7) are identical. As seen in the FIG. 18, both tracks (6, 7) have a rectangular section, with a side (57) partially closed with an opening (56) that allows the insertion, and internal movement of the bottom turning set (12, 27, 28) and the top turning set (11, 25, 26). The opening (56) is defined by two equidistant sides of the track (7). One side (47) has a flat aluminium wall and the other one (48) has a set of protuberances (49) that forms a virtual wall, equidistant from the former wall. The top (6) and bottom track (7) are fixed to the floor and ceiling using nails, screws (59) or similar fixation elements. They drill into the notch, with a channel shape (51), all along the side opposite to the opening (56) in the tracks (6, 7). This channel (51) makes the drilling of the fixation elements easier when fixing the tracks (6, 7) to the floor and the ceiling. In the outer side of the arm (57) that forms the opening (56) there are three channels (52, 53, 54). Channels (52, 53) are equidistant and accommodate the strips made of a homogeneous mixture of self-lubricating polymer (8) in the bottom track (7) and accommodate wind and water protecting brushes (55) in the top track (6). Over those strips made of a homogeneous mixture of self-lubricating polymer (8) the panes (1) slide, resting all their weight on those strips (8). Channel (54) in the bottom track (7) is a water collection channel in case of any water leakage at the pane joints, as this is the most probable point of water and wind entry as it is a natural discontinuity of the glass. Water flows to the inside of the bottom track (7) trough some drills, parallel to the track direction, done in this channel (54) and the water flows out of the track through some exterior holes done during the installation of the system.

A variation of this windbreak system includes a sliding door that can be operated manually sliding along the top (6) and bottom track (7). This sliding door, not shown in the figures, has a pane (1) with a modified version of the bottom bushing axis guide of the panes (1), previously described, to ease the pivot movement of this sliding door. The rest of the components of the bottom turning set and the top turning set are identical to the other panes (1). Therefore, the bottom axis (13) is welded at the hole (20) in the semicircular section of the steel plate (12), as in the rest of the panes (1). This steel plate (12) is placed inside the bottom sliding profile (5) hole. This bottom axis (13) crosses and holds a bushing, not shown in the drawings, with five layers, in a very similar fashion to the bushings (14). Therefore, the sliding door bushing, made of polyamide or a similar material, has this configuration:
A bottom cylindrical base designed to fit by pressure in the semicircular hole (32) of a plate (31) fitted inside the bottom track (7).
A bigger diameter cylinder that is in permanent contact with the vertical inner walls of the bottom track (7).
Another transition cylinder working as a step between the top and bottom cylinder.
The smallest diameter cylinder that is in contact with the sides of the opened area of the bottom track (7). This cylinder fits the top opening of the bottom track (7).
Finally, on top of the smallest diameter cylinder there is a fourth cylinder with a slightly bigger diameter than the size of the top opening of the bottom track (7) to hold this bushing and avoids that it falls into the bottom track (7) hole.

As depicted in FIGS. 23 and 24, this plate (31) has a long rectangular shape and it has a long hole (67), a circular one (68) and an opening (32) with the shape of a semicircular notch in the edge closer to the hole (68). These three elements are in line. The long hole (67) is used to position the plate (31) inside the bottom track (7) being fixed by a screw that drills the channel (51) in the bottom track. The second hole (68) is crossed by a screw that fixes the plate (31) to the interior of the bottom track (7). The semicircular notch (32) has a diameter equals to the cylindrical base of the sliding door bottom bushing. Therefore, this set of the semicircular notch and cylindrical base work as the pivot axis for the sliding or flying door. The pane of the sliding or flying door is an intermediate solution between a pane and a door. This configuration adds flexibility to the system as it allows positioning the sliding door in the other endpoint of the track, opposite side of the door (24). The sliding door is folded like the rest of panes (1), close to the door (24), once all the panes (1) have been folded, and the sliding door is the first to be unfolded when all the panes (1) are folded.

This sliding door can be placed in the other endpoint of the track, opposite side of the door (24). To allow the opening of this door and leave the tracks (6, 7) in the other endpoint of the track, at the opposite side of the door (24) a hole is done in the top track (6) with a size of one centimetre bigger than the diameter of the top bushing guide (18) and a notch in the polymer strip (8) with a size of one centimetre bigger than the diameter of the H washer (19), both located at the same distance from the sliding door pivot axis and in a position where the sliding door is going to be open and close.

Another possible configuration is having two doors (24), in each endpoint of the system and a sliding door that can be open and close in the middle of the system

1-17. (canceled)

18. A windbreak system comprising a set of foldable and independent panes sliding in a longitudinal way along a top track and a bottom track that supports the weight of every pane, and a foldable and non-sliding door with a pivot axis, the foldable and non-sliding door and the panes having a pivot and folding axis wherein each pane and door has a glass glued to:
an internal flat face of the side arms, ending with protuberances up to 0.5 millimetres long, in an aluminium H-shaped top profile, and a flat base, the base located on the opposite side of the opening that forms a top profile hole,
the internal flat face further having two interior walls that delimit a half open rectangular hole in its bottom side where two adjustable screws are placed to regulate the height of this profile in relation to the base of a bottom sliding profile with a H shape, and further having two straight arms to cover the side arms of the bottom profile and slightly curved at its top, wherein the base and two perpendicular arms form a hollow section in the profile that forms the pane support,
and wherein the bottom track is identical to the top track with rectangular sections, and having a side half open whose opening is delimited by two equidistant sides in the track and, because one inside wall of the track is flat and the other vertical wall has a set of protuberances that form a virtual wall equidistant from the former, the track side in contact with the ceiling or floor has a notch channel all along the inner face opposite to the track opening, and the exterior face of the side that forms the opening has two equidistant channels where two strips, one on each channel and made of a homogeneous mixture of self-lubricating polymer, are fitted in the bottom track and brushes are placed in the top track, and a third channel working as a water collection channel, and the bottom track has some drills, parallel to the bottom track sides, wherein the profile connected to the top track is connected by:
the pivot axis with a T axis guide that crosses the top guide bushing and whose base is fitted to a hole in the steel plate placed in the hole of the profile and by the folding axis with a screw that crosses a top hollow guide bushing and is screwed in another steel plate placed in the hole of the top profile,
while the bottom sliding profile connects to the bottom track by the axis guide that crosses a bottom bushing guide and its semicircular base is welded to a steel plate placed in the hole of the profile and wherein the bottom side of the bottom profile rests all the weight of the pane on two strips, made of an homogeneous mixture of self-lubricating polymer, fitted in the channels in the bottom track.

19. The windbreak system comprising a set of independent panes and a door, according to claim 18, wherein there is a pivot axis in every pane formed by a top turning set with a long steel plate that includes two threaded holes with the same diameter and positioned in line to a third hole with a semicircular shape at one end of the steel plate, the steel plate being fixed longitudinally, by two endless screws, to the inside of the top profile hole, the T axis guide inserted in the steel plate at the semicircular hole after crossing the top guide bushing and placed in the interior of the top track and having two layers in a solid block made of polyamide or similar material, the T axis guide being formed of stainless steel with a T shape whose head has an oval shape with two long straight sides,
a bottom turning set with a steel plate identical to the plate fixed longitudinally by two endless screws to the interior hole of the bottom sliding profile, and fitted and welded to the steel plate at its hole to the steel axis guide that is inserted into the bottom bushing guide,
the bottom bushing guide formed of polyamide or similar material and formed by five layers moving inside the bottom track,
the base having an oval shape with two long straight arms the same size as the head of the top T axis guide, the second layer has a larger diameter and is in contact with the vertical walls of the bottom track, the third and fourth layer have smaller diameters and form a step, the diameter of the fourth layer the same as the opening width in the bottom track and the fifth layer has a diameter equal to the distance between the interior sides of the polymer strips placed in the channels in the bottom track,
a turning mechanism placed inside the top and bottom track close to the door pivot axis or pane with a long and straight piece, with a rectangular side that is screwed to the side of the tracks in contact with the floor or ceiling, a flat side that touches the inner wall of the tracks and in the opposite face has a set of corners and curves like a spoon shape in a number equal to the panes present in the systems,
and wherein there is a folding axis for each pane located at a certain distance from the pivot axis and formed by:
a top guide screw crossing a hollow cylindrical bushing made of plastic that stands out of the top profile of each pane and fixed the screw to a threaded hole in the steel plate, which is fixed longitudinally, by means of two endless screws, into the hole of the top profile,
a cylindrical washer made of polyamide with an H shape having two circumferences, joined by an axis, whose top side is placed inside the hole of the sliding profile and the axis, with a smaller diameter, in the opening of the sliding bottom profile in such a way that the bottom side of the washer is not resting on the bottom track.

20. The windbreak system comprising a set of independent panes and a door, according to claim 19, wherein a top screw guide, bushing and the H washer leave the top track through a unique hole, with a size one centimeter bigger than the diameter of the top bushing guide, for the top folding of the panes in the top track and a notch in the polymer strip with a size one centimetre bigger than the diameter of the H washer, the top guide screw, bushing and H washer at the same distance from the door pivot axis, and a guide-arm that stands out the top track in a perpendicular way.

21. The windbreak system comprising a set of independent panes and a door, according to claim 20, wherein a guide-arm, made of stainless steel and having a flat side parallel to the floor including two holes, stands out perpendicularly to the top track, another side is perpendicular to the side that stands out perpendicularly from the top track and a step side fixed, by means of three screws placed in the holes, to the side of the top track touching the ceiling.

22. The windbreak system comprising a set of independent panes and a door, according to claim 21, wherein there is a door with a ventilation mode or partial opening and another locked position based in a locking system comprising a hole crossed by a screw that fits into the steel plate, which is placed inside the top profile hole and a rod including a spring and crossed by a pin that is inserted into the guide-arm hole to achieve the partial opening of the door and into the guide-arm hole to lock the door.

23. The windbreak system comprising a set of independent panes and a door, according to claim 22, wherein the positioning in each pane of the top guide screw, bushing, steel plate and the cylindrical washer in different points is defined by the folding order in the turning mechanism.

24. The windbreak system comprising a set of independent panes and a door, according to claim 19, wherein the door is located in one of the track ends, the top edge of the glass fixed to top profile and the bottom edge to a bottom sliding profile using a adhesive material, and each door pivot axis is formed by a screw whose head is inserted inside a pivoting cube made of polyamide or a similar material, and its base is screwed into a steel plate that is fixed to the top and bottom sliding profile by means of two endless screws, having the pivoting cube another hole, in the opposite side to the former with a smaller diameter, crossed by a screw whose head is inserted into the pivoting cube too and it is screwed to the floor or the ceiling and wherein the door has a locking rod inserted into the guide-arm in conjunction with a lock placed at the bottom of the door.

25. The windbreak system comprising a set of independent panes and a door, according to claim 24, wherein an intermediate sliding door, configured with the same parts as the rest of the panes with the exception that the bottom pivot axis that is formed by a plate, placed inside the interior of the sliding bottom profile, with a semicircular hole where the axis guide is inserted and welded, the other axis guide end is inserted into a bushing, made of polyamide or similar material, with five layers, wherein the base layer cylindrical, the second layer has the biggest diameter and is in contact with the vertical walls of the bottom track, the third and fourth layer have smaller diameters and form a step, and further wherein the diameter of the forth layer is the same as the opening width in the bottom track and the fifth layer has a diameter equal to the distance between the interior sides of the polymer strips placed in the channels in the bottom track.

26. The windbreak system comprising a set of independent panes and a door, according to claim 25, wherein the sliding door moves until reaching the further point from the door where a plate is fitted inside the bottom track, wherein the plate is rectangular and contains a long hole, a circular hole and an opening like a semicircular notch, with a diameter equal to the bottom cylindrical base of the bushing, wherein the bushing base fits in and they both define the pivot axis of the sliding door, and at the opposite side of the door a hole is formed in the top track with a size of one centimeter bigger than the diameter of the top bushing guide and a notch in the polymer strip with a size of one centimeter bigger than the diameter of the H washer both located at the same distance from the sliding door pivot axis and in a position of the folding axis.

27. The windbreak system comprising a set of independent panes and a door, according to claim 18, formed by a set of foldable and independent panes sliding in a longitudinal way along a top track and a bottom track that supports the weight of every pane, and a foldable and non-sliding door with a pivot axis, wherein the panes and door a pivot and folding axis has a glass glued to:
an internal face of the side arms and the flat base in the top profile wherein the side arms have an arm shape having on their inner faces small protuberances up to 0.5 millimetres long, and wherein both arms have a cavity on the top area and the terminations of these arms have two flat sides, and the bottom area of the profile has an inverted “U” shape hole to insert and fix the top turning set and top guide set;
the side arms internal faces and a flat base of the bottom aluminium profile wherein the side arms have, on interior faces, small protuberances up to 0.5 mm long and the bottom area of the profile has an inverted “U” shape hole to insert two bolts that fix this profile to the bottom sliding profile base,
wherein the top profile is connected, at the folding axis, to the top track by a top guide set formed by a metal body and a top guide bushing wherein the metal body is a plate with two layers, an axis and a protuberance, and on the first layer there are small protuberances, and wherein the third layer has a downward slope at its front end, and the width of the second layer has the same width as the profile opening, and the top guide bushing has a circular shape and is one piece made of polyamide or similar material being inserted by pressure into the cylindrical axis head of metal body and the outer diameter in the bushing has a width similar to the opening in the top track, and being the bottom sliding profile connected, at the folding axis, to the bottom track by a bottom guide set formed by a metal plate and a washer, made of polyamide or similar material, and the base of the metal body is a plate with two layers, on the first layer there are small protuberances, up to 0.5 mm long, at the opposite side of the first layer the base has a channel with a width equal to the width of the opening of the aluminium bottom profile and the height of the second layer is the same as the thickness of the base of the bottom profile and the washer, made of polyamide, has a round shape and a hole along its vertical axis, having two layers with different diameters, the bigger diameter layer and the washer head has a smaller diameter than the former, and the polyamide washer is inserted in the metal body by pressure through its cylindrical interior hole into a pin based on the first layer of the metal body and with a height equal to the second layer.

28. The windbreak system comprising a set of independent panes and a door, according to claim 27, wherein bottom track accommodates in a “U” shaped levelling profile, resting on some levelling sets formed by an eccentric bolt, with the precise dimensions to fit perfectly in the levelling profile base, and a flat head screw, resting all these sets completely on the base of the profile, wherein there are two corner holes to insert a cap and wherein a cap is placed at the ends of the bottom track, the cap shape is the same as the track hole, the bottom side is flat and the top side narrows so it can fit into the hole, wherein one vertical side flat and the opposite vertical side has a contour with protuberances complementary to the protuberances of the bottom track.

29. The windbreak system comprising a set of independent panes and a door, according to claim 28, wherein the pivot axis of each pane is formed by:
a top turning set having a metal body and a top guide bushing, the metal body base is a plate with three layers and a protuberance wedge shaped, the first layer has a reference mark, in the second layer there are small, teeth-like protuberances, up to 0.5 mm long, and the width of the third layer, showing the top guide bushing a circular shape and two layers being the biggest dimension of the bushing, and the bushing is inserted by pressure into the rounded axis metal head of the top turning set,
a bottom turning set having bottom guide bushing, a metal plate and another metal part with an oval shape and straight sides, being these metal bodies assembled by a square click locking joint, and the base of the metal body is a plate with three layers and a protuberance, in the first layer there is a reference mark, the second layer has on its surface small protuberances and the width of the third layer has the same width as the profile opening, the protuberance has a wedge shape and the bottom guide bushing has a “T” shape, the side faces are flat and the front and rear side faces are rounded and the bushing width is smaller than the aluminium track opening, being centred, but not fixed, in relation to the set axis,
a pivot block and turning mechanism, wherein, the pivot block has a rectangular shape in all its sides, and a hole where the door axes are inserted, that is slightly off centred, and the external sides of the pivot block and the other two sides have a protuberance and a hole for the assembling with the turning mechanism, having on one side a rectangular extension to match the turning mechanism and the turning mechanism has the same protuberances and holes as the pivot block but in a reverse position, including two holes, and the hole closer to the block pivot has a bigger diameter than the other one, and has two spoons

30. The windbreak system comprising a set of independent panes and a door, according to claim 29, wherein the panes and the door pivot with the help of a mechanism formed by a metal axis and a blocking bushing wherein:
the metal axis has a cylindrical shape with three different areas, a bottom area that has a semicircular shape, a the middle of the axis area where there are two wings connected, with a ramp shape and at the top of the axis there is a head with a small ramp in its base and the front side of the head has a rounded shape and will block the pane when folded, as the axis rotates approximately 90° in relation to the blocking bushing, being blocked to the interior semicircular faces,
the blocking bushing has a circular shape, with a central hole and two layers, showing the hole as an oval shape with straight arms grasping the metal axis, and the first layer has a ramp that rests on the ramp of the metal axis, and the second layer is symmetric to the central vertical axis and has an interior ramp in the inner hole and two rounded sides that block the metal axis.

31. The windbreak system comprising a set of independent panes and a door, according to claim 30, wherein the door locking system includes a top locking block, made in one piece by injection, the block is a rectangular parallelepiped with two protuberances and a short semicircular side with a hole, of a bigger diameter than the hole, placed on the top side, opposite to the protuberance of the block, having a protuberance aimed to position it perpendicularly to the top aluminium profile, and another protuberance in the front side that works as a stopper against the interior side of the top aluminium profile.

32. The windbreak system comprising a set of independent panes and a door, according to claim 31, wherein the sections that are not in line include a two-part adjustable corner plate having two identical plates connected by a joint in the plates rounded shape sides having a step delimited by two straight edges forming an interior angle of 270° and the other small sides are straight, and along the central axis of the plates there is an oval hole, whose longer axis is parallel to the longer sides of the plate, and a circular hole, being the oval ones closer to the small straight side of the plates and wherein a wedge has three layers, the first layer is a base placed underneath the two-part adjustable corner plate, the second layer is shorter and narrower than the other two layers and the third layer has a rounded shape.

33. The windbreak system comprising a set of independent panes and a door, according to claim 32, wherein the top turning guide metal body, the two metal bodies in the bottom turning set, the caps, the locking block, the turning mechanism and its pivot block, the two-part adjustable corner plate, metal axis and the blocking bushing, the plate in the bottom guide and the wedges are made in one piece by injection using aluminium, stainless steel or other metal alloys.

34. The windbreak system comprising a set of independent panes and a door, according to claim 33, wherein each pane and door has a tempered glass sheet with a thickness within a range of 6 to 20 millimetres and the maximum pane height is about 3.5 meters.

35. The windbreak system comprising a set of independent panes and a door, according to claim 33, wherein the pivoting and sliding movement of every pane and door is done manually and without any bearings.

36. The windbreak system comprising a set of independent panes and a door, according to claim 33, wherein in between two panes there is a transparent rigid plastic strip placed by pressure and fitted in the glass edge and there is no fixation element.

37. The windbreak system comprising a set of independent panes and a door, according to claim 33, wherein an adhesive brush is placed in the edges of the glasses to cover the hole in between two consecutive panes.
